(19) United States
(12) Patent Application Publication
(10) Pub. No.: US 2005/0108186 A1
(43) Pub. Date: May 19, 2005

(54) Textual filesystem interface method and apparatus

(76) Inventor: Eric Anderson, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/699,486

(22) Filed: Oct. 31, 2003

(51) Int. Cl. G06F 7/00

(52) U.S. Cl. 707/1

(57) ABSTRACT

A method and apparatus is used to create a filesystem with transaction based functionality. Creating the filesystem includes receiving an indicator to initiate a transaction for files stored in one or more portions of the filesystem, duplicating the one or more portions of the filesystem within a pseudo-filesystem, and creating a control text file that receives text-based commands to operate on the pseudo-filesystem. In addition, the method and apparatus can also be used for interfacing with a filesystem. The interfacing operation includes receiving a text-based command in a command file for operating on a pseudo-filesystem corresponding to the filesystem within a transaction, determining whether one or more data dependencies would prevent the text-based command from being performed on the pseudo-filesystem, performing the text-based command and potentially modifying the pseudo-filesystem, the filesystem and one or more corresponding files associated with the pseudo-filesystem and filesystem respectively.

### BACKGROUND OF THE INVENTION

The present invention relates to the organization of storage systems and improving storage system functionality.

Operating systems use filesystems to organize data in logical units that applications and users can easily use and manipulate. The files in the filesystem are typically stored in a hierarchical tree structure identified with a name and may include properties identifying the size of the file in bytes and the data format or the application used to process the files. Conventional filesystems used to organize and make files available work fine when only a single process reads or writes the files. If only one process reads files, it can be ensured that the information being read is accurate, consistent, and up-to-date. Likewise, a single process writing to files can be ensured that subsequent processes will receive consistent updated information.

Ensuring data consistency is a more difficult problem when multiple users or processes access the same set of files. A process reading data from a shared file may see unexpected and inconsistent updates from other users or processes. To avoid this scenario, a file lock may be applied to a file while it is being modified. While this sometimes may work, it is not always reliable. In some cases, the locking mechanism is only advisory and does not prevent files being read or written. Also, a file lock can lead to deadlock situations when two or more processes or users lock multiple files in an order that cannot be resolved.

File sharing is even more difficult and complicated when using remote file sharing solutions. Network filesystems (NFS) and other remote file sharing schemes may incur a delay before updates to a file or filesystem are made available to other users or processes. This may be due in part to inherent network delays or to the stateless design adopted by these remote file sharing solutions to improve performance. Consequently, data content presented to different users or processes may be inconsistent.

Despite these limitations, filesystems remain a preferable method of storing data on large-scale and enterprise systems. Users and processes continue to tolerate or work around the problems of conventional filesystems rather than adopt more sophisticated mechanisms like databases. In part, this is because databases offer complex interfaces to the data that many applications cannot readily adopt. Furthermore, many operations commonly performed on filesystems are inefficient on databases. It is both more cost-effective and technically feasible to struggle with the inadequacies of conventional existing filesystem than to struggle with interfaces that do not naturally support filesystem-type operations.

If filesystems offered more reliable and accessible file sharing technology, managing large and small computer systems would be easier and more sophisticated applications could be developed.

### BRIEF DESCRIPTION OF THE DRAWINGS

FIG. 1 is a block diagram representation of a system using a transactional filesystem with a text based interface in accordance with one implementation of the present invention;

FIG. 2 is a block diagram depicting more details on the organization of data and files in a transaction based filesystem in accordance with one implementation of the present invention;

FIG. 3 is a flow chart diagram of the operations associated with creating a transactional filesystem with a textual interface in accordance with one implementation of the present invention;

FIG. 4 is a flowchart diagram of the operations associated with interfacing to a filesystem in accordance with one implementation of the present invention;

FIG. 5 provides the operations associated with performing a commit command entered in the control text file in accordance with one implementation of the present invention; and

FIG. 6 is a block diagram of a system used in one implementation for performing the apparatus or methods of the present invention.

Like reference numbers and designations in the various drawings indicate like elements.

### SUMMARY OF THE INVENTION

One aspect of the present invention is used to create a filesystem with transaction based functionality. Creating the filesystem includes receiving an indicator to initiate a transaction for files stored in one or more portions of the filesystem, duplicating the one or more portions of the filesystem within a pseudo-filesystem, and creating a control text file that receives text-based commands to operate on the pseudo-filesystem.

Another aspect of the invention is used for interfacing with a filesystem. The interfacing operation includes receiving a text-based command in a command file for operating on a pseudo-filesystem corresponding to the filesystem within a transaction, determining whether one or more data dependencies would prevent the text-based command from being performed on the pseudo-filesystem, performing the text-based command and potentially updating the pseudo-filesystem, the filesystem and one or more corresponding files associated with the pseudo-filesystem and filesystem respectively.

The details of one or more embodiments of the invention are set forth in the accompanying drawings and the description below. Other features and advantages of the invention will become apparent from the description, the drawings, and the claims.

### DETAILED DESCRIPTION

Aspects of the present invention are advantageous in at least one or more of the following ways. A filesystem with transactional capabilities allows users to both share and update files in a robust manner. Users across a large enterprise can use the filesystem to manage changes to documents and files without expensive and complex additional document management software. The filesystem having transactional capabilities leverages existing features and tools provided by the filesystem thus making the solution more elegant and integrated than add-on software systems and packages. For example, existing security measures built into the filesystem can also be used by the transactional aspects of the filesystem in accordance with the present invention.

Further advantages of the present invention are realized when doing large enterprise-level software system updates and modifications. Implementations of the present invention allow a system administrator or user to upgrade or change many files within a filesystem without taking down large portions of the system to upgrade. Instead, the present invention implements one or more concurrency control schemes and rollback techniques to ensure that updates are made without disrupting normal data processing on the enterprise system.

These updates and transitions are made atomically to the filesystem to ensure that users and processes have a consistent view of the filesystem and files contained therein. Changes to files are staged in a pseudo-filesystem and then applied to the existing filesystem provided no concurrency problems are detected among the many files. If the updates cannot be performed safely, implementations of the present invention automatically refuse to apply the updates until a later point in time. For example, one or more transactions or updates could be applied through a merge operation at a later point in time that combines one or more updates when the system is stable or has otherwise quiesced.

Yet another advantage of the present invention is an agnostic and text-based command interface and status reporting mechanism. The user creating the transaction based filesystem is given a set of files and text commands to interface with the filesystem. These text commands are entered into a command file to perform particular operations on a pseudo-filesystem and later applied to the underlying filesystem. Similarly, text results entered into a status file indicate the status of the commands and are readily available to applications and users using the system.

Previously, these types of interactions have not been made available to users of a computer system and a filesystem despite security and access permissions. Even the interfaces provided to other transaction based filesystems are limited to system calls and complex proprietary interfaces. These interfaces not only make using these features more difficult but they can also require recompiling or modifying many different applications. Accordingly, it is difficult or impossible for a process to use existing interfaces to access files in multiple ongoing transactions. Using implementations of the present invention these constraints are lifted as text commands can be created quickly from a variety of means by a user or application alike subject only to their already existing security and access constraints built into the filesystem and operating system environments.

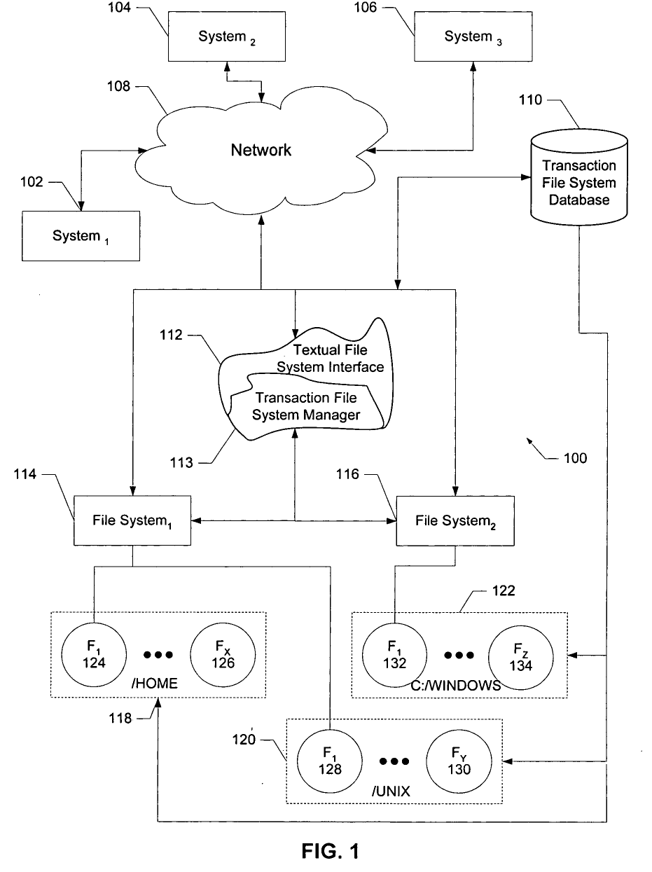

FIG. 1 is a block diagram representation of a system using a transactional filesystem with a text based interface in accordance with one implementation of the present invention. System 100 includes system₁ 102, system₂ 104, and system₃ 106 accessing one or more filesystems over network 108. Textual filesystem interface 112 and transaction filesystem manager 113 designed in accordance with implementations of the present invention work together to provide the interface and transactional functionality respectively.

In one implementation, textual file system interface 112 and transaction file system manager 113 include all services needed for a filesystem designed in accordance with the present invention to operate. This includes managing the pseudo-filesystem interface and data as well as the operations including rollback and low-level atomic commits.

Alternate implementations can instead use a separate transaction filesystem database 110 illustrated in FIG. 1. Instead of integrating these functions, this alternate design uses a separate component (i.e. the transaction filesystem database 110) to provide backend database services to one or more filesystems as required by the present invention. This transaction filesystem database 110 can run a database program compatible with SQL or other databases while keeping the details of the interface masked by textual filesystem interface 112. As illustrated in this example, filesystem₁ 114 may include a /home subdirectory 118 having files F₁ 124 through files F_{X} 126 and a /UNIX subdirectory 120 having files F₁ 128 through F_{Y}130. Filesystem₁ 114 is compatible with a UNIX or Linux based filesystem and file structure. Filesystem₂ 116 can be a FAT32, NTFS, or other filesystem compatible with the Windows Operating systems and include a C:/WINDOWS subdirectory 122 having files F₁ 132 through F_{Z} 134. Alternate implementations of the present invention can organize the subdirectories described above into separate filesystems and may also implement the filesystems according to different operating systems and filesystem organizational schemes other than UNIX, Linux, or Windows (i.e., FAT32 or NTFS) as deemed necessary by the particular implementation or particular installation.

In operation, a user or application running on system 102 uses implementations of the present invention to update one or more files in the above described filesystems. The user or application can control the manner in which that filesystems treat the files by entering commands into a command text file read by textual filesystem interface 112. Similarly, the user or application can also retrieve status on the processing of these commands in a status text file. By using a transaction, the user or application can modify one or more files in the above described filesystems atomically without impacting operation of the underlying operating system or work being performed by other users. A text command entered by a user or application to “commit” the transaction causes the modified files and information to be permanently written to the filesystem. The files and information are made atomically visible to all processes. Operations associated with atomic operations in the filesystem and managing the concurrency between competing consumers of filesystem resources are handled, in part, by transaction filesystem manager 113. Transaction filesystem manager 113 manages these functions on behalf of many different processes in response to predetermined text-based commands entered into files. For example, a “commit” command entered into text-based command file causes a commit to occur on the associated transactions.

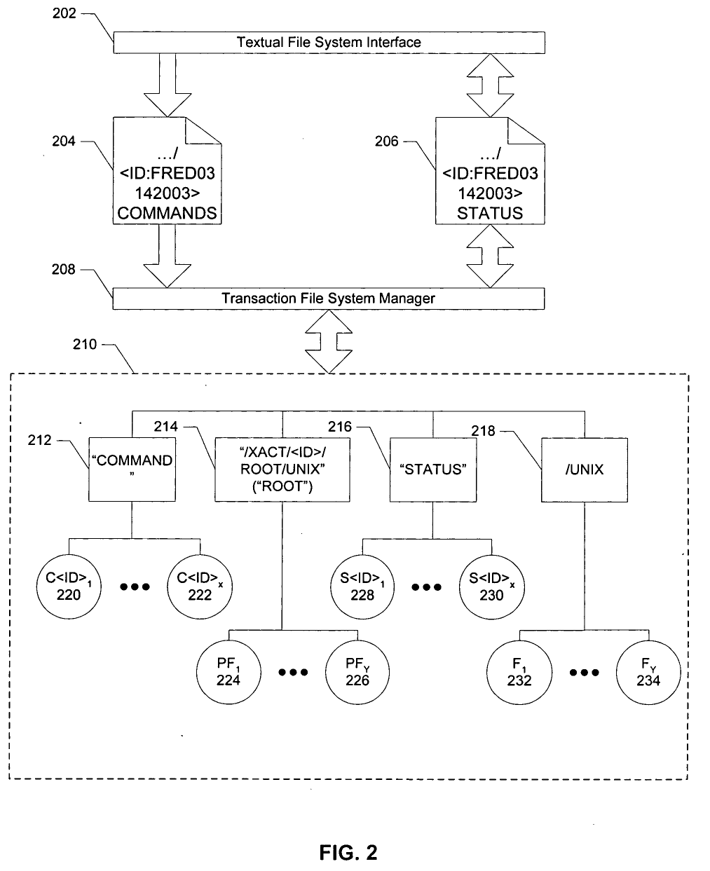

FIG. 2 is a block diagram depicting more details on the organization of data and files in a transaction based filesystem in accordance with one implementation of the present invention. This example includes a textual filesystem interface 202, a commands text file 204, a status text file 206, a transaction filesystem manager 208, and a transaction enabled filesystem 210. In this case, command text file 204 and status text file 206 are associated with a string identifier “FRED03142003” to set apart these files for a particular transaction.

Transaction enabled filesystem 210 includes a number of additional data structures to support tracking the modifications within the transaction. Most notably, transaction oriented filesystem 210 includes a command module 212 to track command nodes 220 through 222, pseudo-filesystem block 214 to track pseudo-filesystem nodes 224 through 226, and status block 216 to track status nodes 228 through 230. These additional data structures are added in accordance with one implementation of the present invention to an existing filesystem 218 having files F₁ 232 through F_{Y} 234. Each transaction is allocated one of each of the above described nodes and a common identifier that associates each of the nodes with the transaction. While these data structures are shown in transaction enabled filesystem 210, an alternate and more streamlined implementation might instead only keep track of pointers to status nodes and command nodes stored elsewhere in the system.

In this example, existing filesystem 218 holds the kernel information and files for a UNIX filesystem identified as “/UNIX”. Transaction filesystem manager 208 enhances existing filesystem 218 with files F₁ 232 through F_{y} 234 by adding command block 212, pseudo-filesystem block 214, and status block 216 and the respective nodes. Each transaction is associated with an identifier to distinguish one transaction on the filesystem from another. The meta-identifier “<ID>” is associated with a command node, a pseudo-filesystem node, and a status node to facilitate operating on the filesystem within the named transaction.

If multiple transactions are instantiated by users or applications, then multiple different identifiers are created or allocated; one identifier per transaction. From the application or users perspective, the same identifier is used to name and locate command text file 204 and status text file 206 within the pseudo-filesystem. In the illustrated example, the pseudo-filesystem is identified by the path “/XACT/FRED03142003/UNIX” and used by the application to modify or change files under control of the transaction identified by “FRED03142003”. Similarly, the user or application accessing command text file 204 and status text file 206 would specify “/XACT/FRED03142003/COMMANDS” and “/XACT/FRED03142003/STATUS” respectively in accordance with one implementation of the present invention. Textual filesystem interface 202 enables the user or application to access these files through a text editor or other text input application or device. Of course the specific format and syntax of these locations and identifiers are provided as only an example and they could be altered and remain in the spirit and scope of the present invention. For example, these paths could be organized as “/XACT/command/<ID>”, “/XACT/status/<ID>” and “/XACT/root/<ID>” or many other variations.

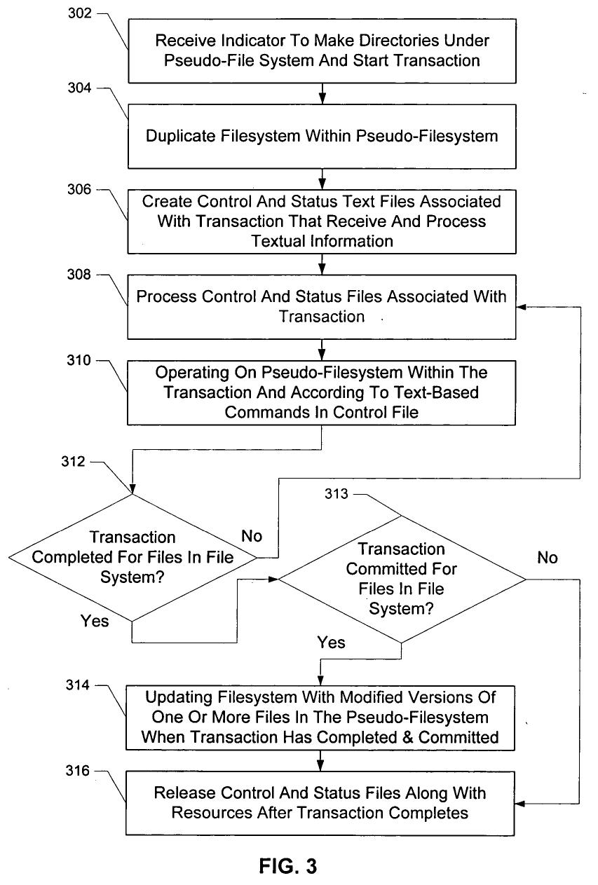

FIG. 3 is a flow chart diagram of the operations associated with creating a transactional filesystem with a textual interface in accordance with one implementation of the present invention. Initially, a textual filesystem interface receives an indicator to start a transaction under a transaction filesystem for files stored under one or more portions of a filesystem (302). In one implementation, the indication is created by a user or application by creating a directory in a pseudo-filesystem directory using a command or system call equivalent. Alternatively, the user or application opens a special file (e.g. /xact/create) whereupon, reading the file returns the identifier of the new transaction. Implementations of the present invention receive the request to make a directory in the pseudo-filesystem directory and start a transaction in the transaction database by issuing a “BEGIN TRANSACTION” type operation if necessary. In general, the transaction ensures atomic updates to the filesystem in accordance with modifications made to the pseudo-filesystem and related files during the transaction.

Upon receipt, the transactional filesystem manager duplicates the filesystem within the pseudo-filesystem (304). In one implementation, a copy of an entire filesystem is created and mounted under the pseudo-filesystem. A lazy duplication strategy may be employed when copying the filesystem to reduce perceived processing impact. In general, a “lazy” strategy performs a particular operation only when conditions or dependencies make it necessary.

The transaction applies to all files in the entire filesystem as the entire filesystem is within the pseudo-filesystem. For example, the entire /UNIX filesystem and files within the /UNIX directory tree would be managed using the transaction created for the filesystem. Alternatively, one or more portions or files of the /UNIX filesystem could be specified and placed under the pseudo-filesystem. In this latter case, only the subdirectories and files placed under the pseudo-filesystem would be subject to the transactional filesystem management control. This could provide flexibility in migrating a legacy filesystem and operating system to the transactional filesystem gradually.

Next, the transactional filesystem manager creates control and status text files for the newly opened transaction (306). The control text file is used for a user or application to enter text commands and interact with the transactional filesystem of the present invention. Commands can be entered into the control text file using a text editor or created by way of scripting programming languages including Perl, Tcl/TK, sh, AWK, sed, Visual Basic, or any other programming language having the ability to create text output for storage in a file. As a result of the commands entered in the control text file or the actions of other processes on the system, the transactional filesystem manager may update the status of the corresponding transactions or effect of other actions by placing status information in the status text file. Like the command file, the information placed in the status text file is in text to ensure that many users or applications can readily read and use the information. To further maintain compatibility, information in both the control text file and status text file may also be implemented using eXtensible Markup Language or XML as well as other tools or programming languages with similar or equivalent features and/or capabilities.

Once the filesystem and files are created, the transactional filesystem manager begins monitoring and processing the control and status files associated with the transaction (308). New commands entered in the control file are monitored at fixed time intervals or in an interrupt-driven manner as they are entered by the user or application. For example, the transactional filesystem manager can inspect the control text file each time it is modified. Depending on the exact command, the transactional filesystem manager operates on the pseudo-filesystem within the transaction (310); as previously described the results of these operations on the pseudo-filesystem are put in the status text file for the user or application to inspect as required. While not described explicitly, it is presumed that multiple users and applications are continuously operating on one or more files as well as possibly the same files in the transaction filesystem thereby updating the control and status files.

Processing on the pseudo-filesystem and corresponding files continues until the transaction is completed (312). Events causing the transaction to complete could be an explicit text command placed in the control text file to terminate the transaction or an operation that implies the transaction should end. For example, removing the transaction directory and control or status files within the transactional filesystem would imply that the transaction has been completed. Removing one or more of these particular files could be interpreted as a request to either abort or commit the transaction as determined by default system wide settings or by the user in a configuration file. Alternatively, an ABORT command placed in the control text file also would serve to explicitly indicate a desire to terminate the transaction. In the latter case, an ABORT command may be implied when a write or possibly even a read command is made to the normal filesystem on a file previously accessed by the transaction. Alternate implementations can use a variety of different explicit or implicit commands other than the ABORT command to terminate the transaction including other commands that delete directories or files from the filesystem. For example, a commit command placed in the control text file would serve to explicitly indicate that changes in the transaction should be applied to the primary filesystem.

As part of the termination process, the transactional filesystem manager is responsible for updating the filesystem with modified versions of the one or more files and directories as well as other changes made in the pseudo-filesystem (314) when the transaction has also been committed (313). The transaction associated with the pseudo-filesystem helps ensure that either all modified files in the filesystem are properly updated or the update operation is aborted and no files in the underlying filesystem are changed. This requires managing the potential concurrent access and modification of files in operating systems like UNIX, Linux, and Windows where files sharing among multiple users or applications is possible. If multiple files with various dependencies are going to be updated, the transaction based filesystem of the present invention cannot perform the updates if it would violate dependencies among multiple files or otherwise creating conflicts or incompatible files.

In one implementation, the transactional filesystem manager uses optimistic concurrency control (OCC) to control pending writes to the pseudo-filesystems made by different users or processes. Alternatively, pending writes to the same file or files under the pseudo-filesystems can be managed using a lock-based concurrency control (LBCC) in conjunction with the transactional filesystem manager of the present invention. Both OCC and LBCC are described in further details later herein.

These and other concurrency mechanisms allow a user or application to change multiple files within a filesystem by way of the transactional filesystem of the present invention and ensure atomic results. This is important in large enterprises requiring files to be updated without taking systems down. For example, this could be used to update operating systems and other critical files in large scale operating systems with many interdependent files and datasets.

Eventually, the transactional filesystem manager releases control and status files along with resources after a transaction completes (316) as the result of either a transaction completion (312) or a transaction completion and a transaction commit (313).

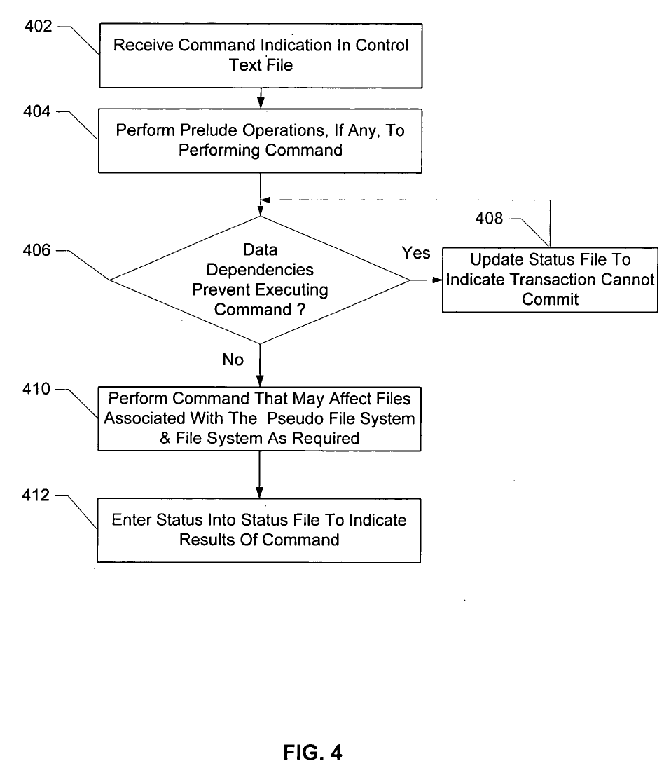

FIG. 4 is a flowchart diagram of the operations associated with interfacing to a filesystem in accordance with one implementation of the present invention. Initially, a user or application enters a command in a control text file to be performed. Implementations of the present invention receive the command in the control text file and begin processing the transaction based request (402). Access and authorization to a file on the underlying filesystem is verified using conventional permission and security mechanisms of the underlying operating system and filesystem. For example, a user or application requesting to modify a file or directory must have proper permissions and authorization for the file or directory from the underlying filesystem. Similarly, the underlying operating system may also require the user or application to have proper permission to execute the text command entered in the control text file. For example, these text-based commands may include changing a root directory, selecting a concurrency control type, selecting an isolation level, committing a transaction, and aborting a transaction. To execute these commands, the user or application may need proper permissions as well as provide sufficient authentication information.

Once the command is received and properly authorized, one or more prelude operations, if any, are performed prior to performing the command (404). The prelude operations may cover a variety of different actions. In some cases, this may require actually creating the pseudo-filesystem, copying the underlying filesystem to the pseudo-filesystem and creating the control and status text files as described above. Alternatively, it may entail identifying and error-checking (i.e., checksum) one or more files for errors in preparation for performing a command for updating a file.

Data dependencies are checked once these prelude operations, if any, are performed (406). In one implementation, checking data dependencies involves managing the concurrent access and pending writes on one or more files in the pseudo-filesystem. If a write-lock or read-lock exists, the status text file can be updated with intermediate status results (408). For example, the intermediate status results may indicate that a lock necessary for reading or writing a file is temporarily unavailable and the requested command is delayed or cannot be performed. An application or user should be able to read the intermediate status from the status text file at all times even if the competing user or application is stalled or delayed until the lock becomes available again.

As previously described, concurrency control can be performed using one of many different concurrency control mechanisms. Optimistic concurrency control (OCC) records all of the files read or written before a transaction is committed and verifies that none of the files have changed before performing the commit operation. If one or more files have been changed, the request made by the user or application is aborted. To improve the performance, a modified OCC can stall the user or application making the request and wait for the other user or application to complete. This may result in higher throughput. OCC is advantageous as it avoids deadlock between processes waiting for the same files or resources.

Lock-based concurrency control (LBCC) is another type of concurrency control that relies on both read and write locks to coordinate concurrent access to files. Before a user or application reads a file, a read-lock is obtained on the file and similarly before the user or application writes a file a write-lock is obtained. Unlike OCC, deadlocks are possible under LBCC as multiple users or applications wait for each other's locks to be released or available. Deadlocks can be terminated by periodically checking for cycles and selecting to abort one of the users or applications in the deadlock. To improve the performance under LBCC, it is advantageous to select the user or application operating for the shortest time period when removing a deadlock. Whether OCC or LBCC, selecting the proper dependency management or concurrency control mechanism depends on the particular needs of the system and performance characteristics desired during operation as well as other constraints of the system.

Once the dependencies are resolved, the requested command is performed and files associated with the pseudo-filesystem & filesystem may be affected (410). If remotely mounted filesystems are involved, a two-phase commit may be necessary for completing the transactions and updating the files. The status results are placed in the status text file in accordance with aspects of the present invention whether the command is success or a failure (412).

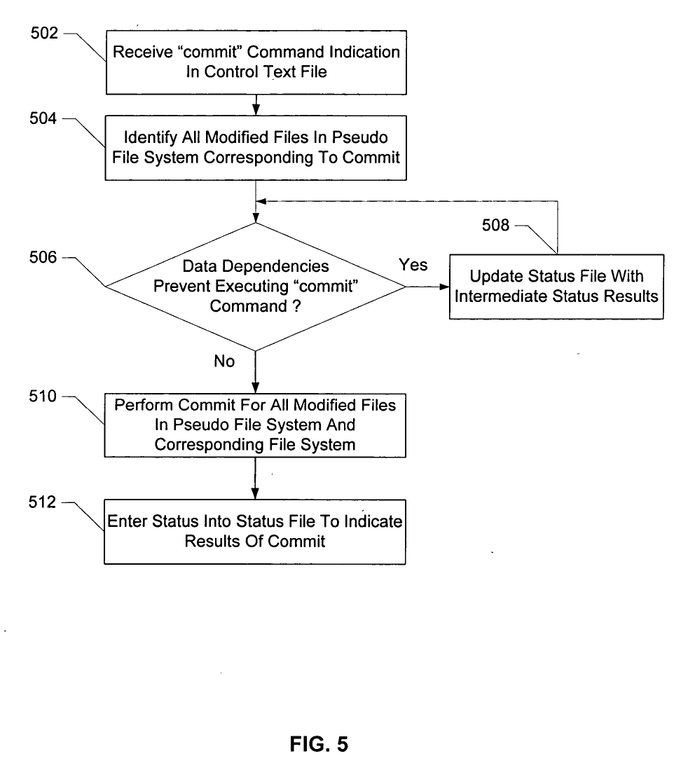

As an example, FIG. 5 provides the operations associated with performing a commit command entered in the control text file in accordance with one implementation of the present invention. Typically, a user or application modifies a number of files in a pseudo-filesystem within a transaction and then enters the “commit” command in the control text file to make the changes permanent in the corresponding filesystem.

In operation, a transactional filesystem manager receives the “COMMIT TRANSACTION” command in the control text file and begins processing within the transaction (502). One prelude or preliminary operation may include identifying all modified files in the pseudo-filesystem subject to the particular transaction (504). In one implementation, all files in a filesystem modified by one or more users or applications are identified for purposes of the commit operation. Alternatively, only a portion of the files in a portion of the filesystem are considered for the commit operation rather than all files in the filesystem.

Next, a determination is made whether data dependencies and other file conflicts, prevent executing the “commit” command (506). As previously discussed, one or more concurrent access management methods can be selected and used to select which of the applications are allowed to complete. If data dependencies prevent “executing” the commit command then a status text file is updated to indicate a commit cannot occur (508). Alternate implementations may wait a predetermined or random time interval before attempting to execute the commit a subsequent time.

In the alternate, if the commit is possible then the commit is performed for all modified files through the pseudo-filesystem (510). In one implementation, modified files in the pseudo-filesystem are copied to the corresponding filesystem from shadow pages stored, for example, pending writes on secondary pages rather than the primary page of data or file. When appropriate, two-phase commits and roll back techniques are also implemented in the event an update to a filesystem fails or cannot complete for some reason. The results of these operations are provided in the status text file to indicate the results of the commit (512) (or other commands) and make the results available to many different programs.

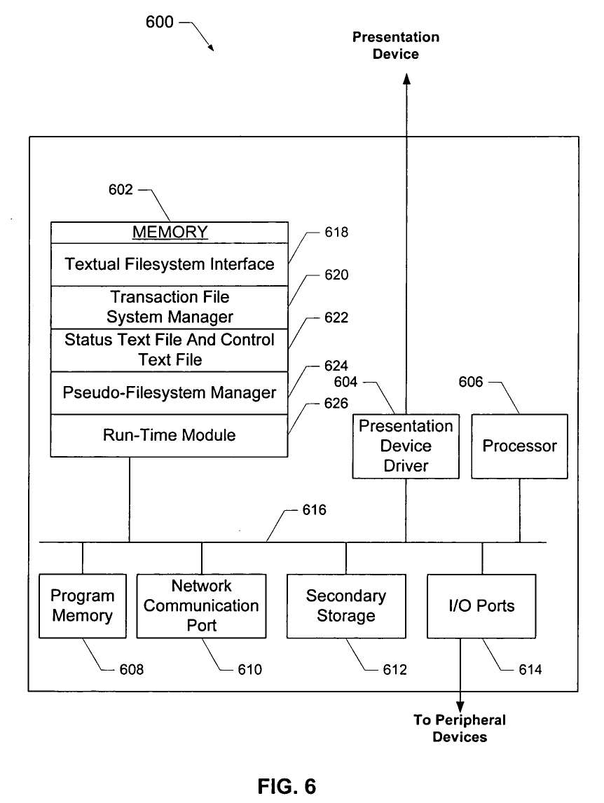

FIG. 6 is a block diagram of a system 600 used in one implementation for performing the apparatus or methods of the present invention. System 600 includes a memory 602 to hold executing programs (typically random access memory (RAM) or read-only memory (ROM) such as a flash RAM), a presentation device driver 604 capable of interfacing and driving a display or output device, a processor 606, a program memory 608 for holding drivers or other frequently used programs, a network communication port 610 for data communication, a secondary storage 612 with secondary storage controller, and input/output (I/O) ports 614 also with I/O controller operatively coupled together over a bus or interconnect 616. The system 600 can be preprogrammed, in ROM, for example, using field-programmable gate array (FPGA) technology or it can be programmed (and reprogrammed) by loading a program from another source (for example, from a floppy disk, a CD-ROM, or another computer). Also, system 600 can be implemented using customized application specific integrated circuits (ASICs).

In one implementation, memory 602 includes a textual filesystem interface component 618, a transaction filesystem manager component 620, a status text file and control text file component 622, a pseudo-filesystem manager 624, and a run-time module 626 that manages system resources used when processing one or more of the above components on system 600.

Textual filesystem interface component 618 is designed to provide an interface to the filesystem using text-based commands in accordance with the present invention. Instead of recompiling source code, applications can interface to this filesystem and the transaction extensions using scripting languages that generate text-based commands. Both applications and users can naturally participate in multiple simultaneous independent transactions. Transaction filesystem manager component 620 instantiates transactions for filesystems and implements policies like OCC and LBCC for concurrent access control when updates are made to the filesystems. Additional functions performed by transaction filesystem manager component 620 include copying the filesystem to the pseudo-filesystem space, initiating, for example, BEGIN, COMMIT and ABORT operations on the transaction, and updating the filesystem with modified files in the underlying pseudo-filesystem.

Status text file and control text file component 622 are used as text-based input and output mechanisms for filesystems designed in accordance with the present invention. A control text file receives text-based commands from users and applications to perform various operations on the filesystem and parallel pseudo-filesystem created for the filesystem. Both intermediate and final results are placed in the status text file as a result of performing one or more of these text-based commands provided by the user or application. For increased flexibility and compatibility, the commands and status entered in both the command and status files respectively may be provided using XML, languages compatible with XML or other extensible formatting languages.

Pseudo-filesystem manager component 624 maintains information in the pseudo-filesystem during a transaction and manages resources used therein. For example, the pseudo-filesystem manager allocates identifiers to each transaction and requests sufficient memory and/or secondary storage to hold the pseudo-filesystems. File allocation tables (FAT), inodes, superblocks, indexes, and other data structures used to organize the pseudo-filesystem are maintained by pseudo-filesystem manager component 624. When a transaction terminates and the pseudo-filesystem is no longer required, pseudo-filesystem manager component 624 relinquishes the resources back to the operating system for use with other processes and components.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents.

1. A method of creating a filesystem with transaction based functionality, comprising:
receiving an indicator to initiate a transaction for files stored in one or more portions of the filesystem;
duplicating the one or more portions of the filesystem within a pseudo-filesystem; and
creating a control text file that receives text-based commands to operate on the pseudo-filesystem.

2. The method of claim 1 wherein the duplicating is performed lazily.

3. The method of claim 1 further comprising:
processing the text-based commands written to the control file;
operating on the one or more portions of the pseudo-filesystem within a transaction according to the text-based commands.

4. The method of claim 1 further comprising:
completing the transaction upon receipt of a text-based command associated with terminating the transaction.

5. The method of claim 3 wherein the text-based commands include functional equivalent commands associated with terminating the transaction and selected from a set of commands for performing one of the following functions: delete directory, delete filesystem, and abort.

6. The method of claim 1 further comprising:
updating the filesystem with the updates performed on the pseudo-filesystem when the transaction has completed.

7. The method of claim 6 wherein the updates are performed upon receipt of an indication to commit the transaction.

8. The method of claim 1 further comprising:
creating a status text file that provides text-based status results from operations performed on the pseudo-filesystem.

9. The method of claim 1 wherein the indicator to initiate the transaction results from the creation of a directory within a pseudo-filesystem.

10. The method of claim 1 wherein the transaction ensures atomic updates to the filesystem in accordance with modifications made to the pseudo-filesystem and related files during the transaction.

11. The method of claim 1 wherein a user assists in reconciliation of conflicts between updates in the pseudo-filesystems.

12. A method of interfacing with a filesystem comprising:
receiving a text-based command in a command file for operating on a pseudo-filesystem corresponding to the filesystem within a transaction;
determining whether one or more data dependencies would prevent the text-based command from being performed on the pseudo-filesystem; and
performing the text-based command and potentially updating the pseudo-filesystem, the filesystem and one or more corresponding files associated with the pseudo-filesystem and filesystem respectively.

13. The method of claim 12 further comprising:
updating a status file associated with the pseudo-filesystem with text-based intermediate status results for performing the text-based command and updates performed in the system.

14. The method of claim 12 further comprising:
updating a status file associated with the pseudo-filesystem with text-based results indicating the final status associated with the command.

15. The method of claim 12 wherein receiving a text-based command includes functional equivalent commands selected from a set including: change root directory, select concurrency control type, select isolation level, commit transaction, and abort transaction.

16. The method of claim 12 wherein determining the one or more data dependencies includes using optimistic concurrency control (OCC) to control pending read and write operations to the pseudo-filesystem, the filesystem and one or more corresponding files associated with the pseudo-filesystem and filesystem respectively.

17. The method of claim 12 wherein determining the one or more data dependencies includes using lock-based concurrency control (LBCC) to control pending read and write operations to the pseudo-filesystem, the filesystem and one or more corresponding files associated with the pseudo-filesystem and filesystem respectively.

18. The method of claim 12 wherein a user assists in reconciliation of conflicts between resources in the filesystem and pseudo-filesystems and files associated with these.

19. A computer program product for creating a filesystem with transaction based functionality, tangibly stored on a computer-readable medium, comprising instructions operable to cause a programmable processor to:
receive an indicator to initiate a transaction for files stored in one or more portions of the filesystem;
duplicate the one or more portions of the filesystem within a pseudo-filesystem; and
create a control file that receives text-based commands to operate on the pseudo-filesystem.

20. A computer program product for interfacing with a filesystem, tangibly stored on a computer-readable medium, comprising instructions operable to cause a programmable processor to:
receive a text-based command in a command file for operating on a pseudo-filesystem corresponding to the filesystem within a transaction;
determine whether one or more data dependencies would prevent the text-based command from being performed on the pseudo-filesystem; and
perform the text-based command and potentially updating the pseudo-filesystem, the filesystem and one or more corresponding files associated with the pseudo-filesystem and filesystem respectively.

21. An apparatus that creates a filesystem with transaction based functionality comprising:
a processor;
a memory having instructions capable of being executed on the processor that receive an indicator to initiate a transaction for files stored in one or more portions of the filesystem, duplicate the one or more portions of the filesystem within a pseudo-filesystem, and create a control file that receives text-based commands to operate on the pseudo-filesystem.

22. An apparatus that interfaces with a filesystem, comprising:
a processor;
a memory having instructions capable of being executed on the processor that receive a text-based command in a command file for operating on a pseudo-filesystem corresponding to the filesystem within a transaction, determine whether one or more data dependencies would prevent the text-based command from being performed on the pseudo-filesystem, and perform the text-based command and potentially updating the pseudo-filesystem, the filesystem and one or more corresponding files associated with the pseudo-filesystem and filesystem respectively.

23. An apparatus for creating a filesystem with transaction based functionality, comprising:
means for receiving an indicator to initiate a transaction for files stored in one or more portions of the filesystem;
means for duplicating the one or more portions of the filesystem within a pseudo-filesystem; and
means for creating a control file that receives text-based commands to operate on the pseudo-filesystem.

24. An apparatus for interfacing with a filesystem, comprising:
means for receiving a text-based command in a command file for operating on a pseudo-filesystem corresponding to the filesystem within a transaction;
means for determining whether one or more data dependencies would prevent the text-based command from being performed on the pseudo-filesystem; and
means for performing the text-based command and potentially updating the pseudo-filesystem, the filesystem and one or more corresponding files associated with the pseudo-filesystem and filesystem respectively.
